(19) United States
(12) Patent Application Publication
(10) Pub. No.: US 2019/0101773 A1
(43) Pub. Date: Apr. 4, 2019

(54) FABRY-PEROT FARADAY ROTATOR ON SILICON SUBSTRATE

(71) Applicants: Bethanie Joyce Hills Stadler, Shoreview, MN (US); Prabesh Dulal, Bloomington, MN (US)

(72) Inventors: Bethanie Joyce Hills Stadler, Shoreview, MN (US); Prabesh Dulal, Bloomington, MN (US)

(21) Appl. No.: 16/147,455

(22) Filed: Sep. 28, 2018

Related U.S. Application Data
(60) Provisional application No. 62/565,387, filed on Sep. 29, 2017.

(51) Int. Cl. G02F 1/09

(52) U.S. Cl. CPC G02F 1/093; G02F 2202/06; G02F 2201/34

(57) ABSTRACT

A Faraday rotator includes: a first reflector comprising a silicon substrate; a magneto-optic layer on the first reflector, the magneto-optic layer having a figure of merit of at least −1200° per centimeter for a predetermined wavelength of input light; and a second reflector on the magneto-optic layer, wherein the first reflector, the magneto-optic layer, and the second reflector are arranged to form an optical cavity.

### TECHNICAL FIELD

This disclosure generally relates to Faraday rotators and methods of fabricating Faraday rotators.

### BACKGROUND

A linearly polarized light beam is equivalent to the combination of two equal but opposite circularly polarized beams. When this beam is passed through a magneto-optic material under application of magnetic field, it experiences a phenomenon called Zeeman splitting—a splitting of the dispersion curves of the two polarizations. This leads to a difference in refractive index at all wavelengths to some degree, which means the two polarizations have different velocities. This difference is called the magneto-optic circular birefringence, also known as Faraday rotation, because the birefringence causes an effective rotation of the linearly polarized light. Materials exhibiting such Faraday rotation are called magneto-optic materials.

Faraday rotation (θ_{F}) depends on three different components, the magnetization of the material (M), thickness of the material (d), and a material constant called the Verdet constant (V) according to θ_{F}=VdM. For a magnetically saturated material, Faraday rotation has units of °/cm, signifying the amount of rotation per unit propagation length in the material. An optical device that is capable of providing a Faraday rotation when a magnetic field is applied is called a Faraday rotator.

An optical isolator can be implemented using a Faraday rotator. An optical isolator is the optical analogue of an electronic diode that only allows light to propagate in a forward direction, and attenuates or blocks back reflected light that propagates in a backward direction. An optical isolator can be used to mitigate effects of back reflections such as spurious amplification, intensity instability and frequency jumps in a laser source.

### SUMMARY

The present disclosure relates to devices including Faraday rotators on silicon substrates and methods for producing the same. In certain implementations, a magneto-optic layer such as cerium-doped yttrium iron garnet (YIG) can be formed on a silicon substrate by depositing a seed layer, annealing the seed layer, depositing the magneto-optic layer, and then annealing the magneto-optic layer. In other implementations, a seed-layer free magneto-optical layer such as cerium-doped terbium iron garnet (TIG) can be deposited directly onto a silicon substrate and annealed. Additionally, a Fabry-Perot optical cavity can be formed to enhance the Faraday rotation experienced by input light using the substrate as one reflector and a distributed Bragg reflector as a second reflector.

In general, in a first aspect, the disclosure features a Faraday rotator that includes: a first reflector including a silicon substrate; a magneto-optic layer on the first reflector, the magneto-optic layer having a figure of merit of at least −1200° per centimeter for a predetermined wavelength of input light; and a second reflector on the magneto-optic layer, wherein the first reflector, the magneto-optic layer, and the second reflector are arranged to form an optical cavity.

Embodiments of the rotator can include one or more of the following features. For example, the magneto-optic layer can include cerium-doped yttrium iron garnet (Ce:YIG) or cerium-doped terbium iron garnet (Ce:TIG) having a predominantly garnet phase. The Ce:YIG or Ce:TIG can be polycrystalline.

In some implementations, a thickness of the magneto-optic layer is in a range of 100 nm to 1000 nm.

In some implementations, the second reflector includes a plurality of low refractive index layers and a plurality of high refractive index layers, the low refractive index layers and the high refractive index layers arranged in an alternating manner along a direction perpendicular to the substrate. The plurality of high refractive index layers can include amorphous-YIG, and the plurality of low refractive index layers can include SiO₂. Each layer of the plurality of high refractive index layers can have a thickness that corresponds to a quarter of a predetermined wavelength of light in the high refractive index layer, and each layer of the plurality of low refractive index layers can have a thickness that corresponds to a quarter of the predetermined wavelength of light in the low refractive index layer. The respective plurality of first and second reflector layers can include a range of 2 to 10 layers.

In some implementations, the first reflector can include a seed layer on the substrate, the seed layer arranged between the substrate and the magneto-optic layer. The seed layer can include yttrium iron garnet (YIG) having a predominantly garnet phase. The YIG can be polycrystalline. A thickness of the seed layer can be between 20 nm and 100 nm.

In another aspect, the disclosure features a method of fabricating a Faraday rotator, the method including: providing a silicon substrate; forming a yttrium iron garnet (YIG) layer on the silicon substrate; annealing the YIG layer to crystalize the YIG layer to form a garnet phase; forming a cerium-doped YIG layer on the YIG layer;

annealing the cerium-doped YIG layer to crystalize the cerium-doped YIG layer and form a garnet phase; forming a reflector on the cerium-doped YIG layer.

In some implementations, the forming of the YIG layer includes: sputtering a Y₃Fe₅ target in an O₂ environment.

In some implementations, the forming of the cerium-doped YIG layer includes: simultaneously sputtering a cerium metal target and a Y₃Fe₅ target.

In some implementations, the annealing of the YIG layer includes rapid thermal processing the YIG layer for 120 seconds at 900° C. in an O₂ environment, and the annealing of the cerium-doped YIG layer includes rapid thermal processing the YIG layer for 120 seconds at 900° C. in an O₂ environment.

In some implementations, the forming of the reflector includes forming a quarter wavelength reflector stack on the cerium-doped YIG layer.

In a further aspect, the disclosure features an optical isolator that includes: an input polarizer having a first axis of polarization; and a Faraday rotator including: a first reflector including a silicon substrate; a magneto-optic layer on the first reflector, the magneto-optic layer having a figure of merit of at least −1200° per centimeter for a predetermined wavelength of input light; and a second reflector on the magneto-optic layer, wherein the first reflector, the magneto-optic layer, and the second reflector are arranged to form an optical cavity.

Implementations of the subject matter disclosed herein may have various advantages. For example, in some implementations, forming the Faraday rotator on a silicon substrate provides a less expensive alternative to the use of garnet substrates, which may significantly reduce manufacturing cost of Faraday rotators. Additionally, the total device thickness may be reduced by using the substrate interface as a reflector. Furthermore, in some implementations, the Faraday rotator can provide tens of degrees of Faraday rotation with low optical loss. Also, up to 100 hours of processing time may be saved by removing the need for a bottom distributed Bragg reflector (DBR) and by optimizing the materials for the disclosed top DBR.

Advantageously, the disclosed device architectures can be achieved using large-area, planar processing techniques (e.g., sputtering), enabling compact, integrated form-factors and large-scale manufacturing in an economic manner. Furthermore, use of silicon substrates can enable back-end-of-line processes to be utilized in subsequent device manufacturing and packaging. This may significantly improve manufacturing efficiency over manual pick and place processes involved in many garnet devices.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic that illustrates an example of a Fabry-Perot Faraday rotator;

FIG. 2 is a schematic that illustrates an example of a Faraday rotator with a seed layer; and

FIGS. 3A and 3B are schematics that illustrates an example of an optical isolator implemented using the Faraday rotator of FIG. 2 according to some embodiments.

Like reference numbers and designations in the various drawings indicate like elements.

### DETAILED DESCRIPTION

Achieving high Faraday rotation in an out-of-plane illuminated Faraday rotator fabricated on a semiconductor substrate is challenging for various reasons. First, integration of magneto-optic (MO) material on a substrate typically benefits from using a substrate formed from a specific material for reasons such as material compatibility and lattice matching. For example, magneto-optical garnets can be grown epitaxially on garnet substrates, such as gadolinium gallium garnet (GGG). Thin layers (e.g., hundreds of nm) of certain types of MO materials such as yttrium iron garnet (YIG) can be grown on semiconductor substrates such as a silicon substrate. However, limited achievable layer thickness and relatively low Faraday rotation (e.g., +200°/cm@1550 nm for YIG) of such materials limits performance of Faraday rotators based on such MO materials. Tens of degrees Faraday rotation would require millimeter thicknesses which are essentially bulk thicknesses (e.g., substrates are typically fractions of millimeters thick).

Certain MO materials, such as doped garnets, including bismuth-doped YIG (Bi:YIG) and cerium-doped YIG (Ce:YIG), can provide higher Faraday rotation (e.g., −4500°/cm@1550 nm for Ce:YIG grown on GGG). However, conventional attempts to deposit such doped-garnets on a silicon substrate often result in formation of secondary phases besides garnet, resulting in lower Faraday rotation and higher optical losses.

The present disclosure is related to an out-of-plane Faraday rotator fabricated on a silicon substrate capable of providing high Faraday rotation (e.g., >5°). Forming the Faraday rotator on a silicon substrate provides a less expensive alternative to the use of garnet substrates. This may significantly reduce manufacturing cost of Faraday rotators, as garnet substrates are typically formed from nonabundant elements and are costly to produce compared to silicon substrates. Furthermore, in some implementations, the Faraday rotator can provide tens of degrees of Faraday rotation. Advantageously, the disclosed device architectures can be achieved using planar processing techniques, enabling compact, integrated form-factors and large-scale manufacturing in an economic manner.

As another advantage, the total device thickness may be lower compared to other Fabry-Perot devices having two DBRs, as the substrate itself may provide the bottom reflector in place of the standard DBR stack. Strain in thin film devices typically increases with thickness, especially when materials require annealing, so the disclosed device improves reliability and repeatability of manufactured devices. Because one DBR can be omitted and the total device thickness can be reduced, strain can be alleviated and significant amount (e.g., 100 hours) of fabrication time can be saved.

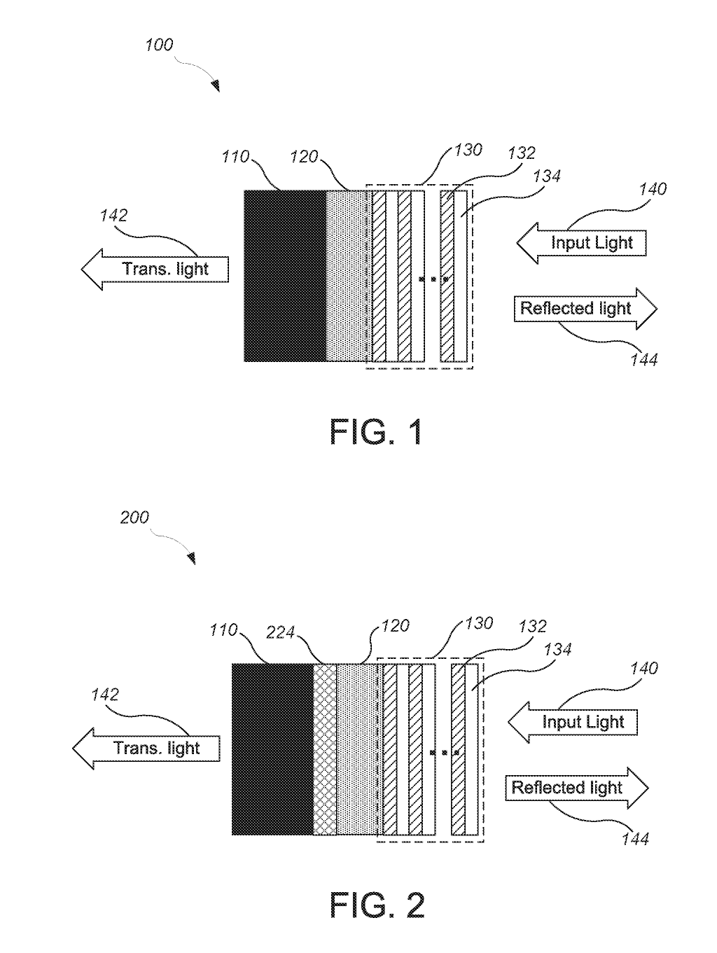

Referring to FIG. 1, a schematic view of an example Fabry-Perot (FP) Faraday rotator 100 is shown. The Faraday rotator 100 includes a substrate 110, a magneto-optic (MO) layer 120, and a reflector 130. The substrate 110, the MO layer 120 and the reflector 130 can form a FP interferometer. Input light 140 is incident on the Faraday rotator 100. Part of input light 140 is transmitted as transmitted light 142, and reflected as reflected light 144.

The MO layer 120 is a layer of magneto-optic material that exhibits a magneto-optic effect (i.e., non-zero Verdet constant). Such MO layer 120 is capable of providing Faraday rotation when a magnetic field in applied parallel to the propagation of the light. Maximum Faraday rotation for a given MO layer type and thickness can be obtained by applying a magnetic field having a field strength sufficient to magnetically saturate the MO material. Examples of MO materials include yttrium iron garnet (YIG), bismuth-doped YIG (Bi:YIG), cerium-doped YIG (Ce:YIG), terbium iron garnet (TIG), bismuth-doped TIG (Bi:TIG), and cerium-doped TIG (Ce:TIG).

The substrate 110 can be formed from various materials. For example, the substrate can be a semiconductor substrate such as a silicon wafer, or a garnet substrate such as GGG or LGG (lanthanum gallium garnet). Silicon is abundant, inexpensive, and widely used in the semiconductor manufacturing industry, which makes a silicon substrate a good candidate on which to fabricate the Faraday rotator.

A reflectivity R due to index mismatch across an interface at normal incidence to the interface can be described by the following equation,

$$R = {[ \frac{{n}_{1} - {n}_{2}}{{n}_{1} + {n}_{2}} ]}^{2} \qquad Equation 1$$

wherein n₁ and n₂ denote the refractive indices of the materials on either side of the interface. For example, silicon has a refractive index of approximately 3.5 at 1550 nm, while Ce:YIG, has a refractive index of approximately 2.1 at 1550 nm. Such combination results in a reflectivity of approximately 6.3%, sufficient for providing a partial reflector of a FP interferometer.

The reflector 130 includes multiple first layers 132 and second layers 134. The first layer 132 and the second layer 134 have different refractive indices. For example, the first layer 132 can be a high refractive index layer and the second layer 134 can be a low refractive index layer, and vice versa. Such an alternating stack of high and low refractive index layers is an example of a distributed Bragg reflector (DBR). By appropriately designing individual thicknesses of the alternating layers, a DBR can be formed that reflects over a desired band (“stopband”) of wavelengths and transmits wavelengths outside of the stopband.

In some implementations, each layer of the reflector 130 of the DBR-type have a “thickness×index” product that corresponds to a quarter of a predetermined wavelength of the input light 140. Such stack of films may be referred to as “quarter-wave stacks.” For example, for a target input wavelength of 1000 nm, a low index layer having a refractive index of 1.5 can have a thickness of approximately 167 nm, corresponding to a quarter of the wavelength of input light in the low index layer, and a high index layer having a refractive index of 2.0 can have a thickness of approximately 125 nm, corresponding to a quarter of the wavelength of input light in the high index layer, to form a DBR. Reflectivity of a quarter-wave stack is augmented by interference, since an interface between materials with indexes of 1.5 and 2.0 would only have 2% reflection according to Equation 1 alone.

An exemplary Fabry-Perot interferometer includes two partially reflecting surfaces that are parallel to each other to form an optical cavity (“FP cavity”) that benefits from the interference phenomenon. For example, the interface between the substrate 110 and the MO layer 120 can provide the first partially reflecting surface and the reflector 130 can provide the second partially reflecting surface. In cases where a garnet substrate is used, a second DBR similar to the reflector 130 may be needed below the MO layer 120, as garnet substrates have essentially the same index of refraction as the MO layer 120 (e.g., garnet). However, by using a substrate 110 having an index of refraction that is substantially different from the MO layer 120 (e.g., a silicon substrate), the second DBR can be eliminated while retaining the benefit of resonantly enhanced Faraday rotation provided by the FP cavity.

Elimination of the second DBR provides various advantages. For example, the time needed to manufacture the second DBR is eliminated, resulting in reduced fabrication time of the Faraday rotator 100. As another example, chances of the second DBR degrading or cracking during a thermal annealing step of the MO layer 120 can be eliminated, resulting in improved device yield.

Now turning to the operation of the FP cavity, when the input light 140 enters the cavity, the light undergoes multiple reflections at the reflecting surfaces. The reflected light and the input light can interfere in a constructive manner or a destructive manner depending on the relationship between the size of the optical cavity and the wavelength of input light. For example, constructive interference can occur if the length traveled by the input light within the cavity is an integer multiple of the wavelength of the input light within the optical cavity, and the FP interferometer would exhibit a transmission maximum. As another example, destructive interference can occur if the length traveled by the input light within the cavity is half of an odd multiple of the wavelength of the input light within the optical cavity, and the FP interferometer would exhibit a transmission minimum, or a reflection maximum at that wavelength. Both the transmitted light 142 and the reflected light 144 from the Faraday rotator 100 experiences Faraday rotation. The design of the Faraday rotator 100 may be varied to change the Faraday rotation experienced by the transmitted light 142 and the reflected light 144. For example, it may be possible to design the Faraday rotator 100 such that maximum Faraday rotation is experienced by the transmitted light 142 or the reflected light 144. While FIG. 1 illustrates the case where the input light 140 enters the rotator 100 through the reflector 130, the FP interferometer and the rotator 100 operates in analogous manner when the input light 140 enters the rotator 100 through the substrate 110.

To enable constructive interference at the desired wavelength of input light, in some implementations, the MO layer 120 may be designed to have a thickness that corresponds to half of the desired wavelength or an integer multiple of the desired wavelength.

Input light can experience multiple reflections back and forth between the two reflecting surfaces of the FP cavity depending on the reflectivity of the two surfaces and the interference condition. By appropriately designing the respective reflectivity of the two reflecting surfaces and the length of the cavity, an interaction length of the input light with a layer forming the FP cavity can be increased, or resonantly enhanced. Such resonant enhancement can be used to enhance the Faraday rotation experienced by the input light.

While the FP Faraday rotator 100 has the potential to provide enhanced Faraday rotation for a given type and thickness of the MO layer 120, using a high Faraday rotation material such as Ce:YIG or Ce:TIG as the MO layer 120 can further improve Faraday rotation achievable by the FP Faraday rotator.

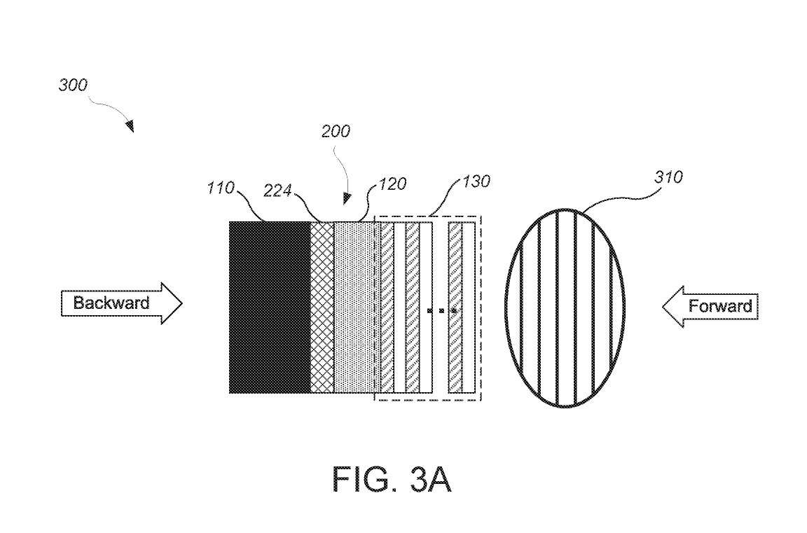

To enable formation of high Faraday rotation MO materials, in some implementations, a FP Faraday rotator includes a seed layer. Referring to FIG. 2, a schematic view of an example of a FP Faraday rotator 200 including a seed layer 224 is shown. The seed layer 224 is provided between the substrate 110 and the MO layer 120.

The seed layer 224 can act as a buffer between the substrate 110 and the MO layer 120 to mitigate mismatches in various physical characteristics between the MO layer 120 and the substrate 110. For example, doped YIG and silicon have very different lattice parameters (e.g. YIG=12.37 Å and Si=5.43 Å), and thermal expansion coefficients. As such, depositing the MO layer 120 directly on a silicon substrate 110 can result in formation of a non-garnet MO layer 120 with low to no magneto-optic effect. The mismatch in lattice parameters and thermal expansion coefficients can be mitigated by the fabrication method disclosed herein.

The Faraday rotator 200 can be fabricated using a method that deposits and anneals a seed layer of YIG on a silicon substrate prior to depositing and annealing a layer of Ce:YIG. An exemplary fabrication method can include the following steps:

First, provide a silicon substrate. For example, a single-crystalline silicon substrate that has been polished on a single side or on both sides can be used.

Second, form a thin layer of YIG (seed layer 224). The seed layer can be formed using, for example, a radio frequency (RF) sputtering technique or pulsed laser deposition. Use of the RF sputtering technique may provide films having good uniformity and low surface roughness. The thickness of the seed layer can vary from about 20 nm to 100 nm (e.g., 45 nm). The resulting YIG layer is typically amorphous at this point.

Third, anneal the YIG seed layer to crystalize the YIG seed layer to form a garnet phase. The annealing can be performed using, for example, a rapid thermal annealing (RTA) technique. The duration, temperature profile, and gaseous ambient can be set to achieve optimal garnet-crystallization of the YIG seed layer. For example, the duration can range from 1 minute to 5 minutes, and the annealing temperature can range from 750° C. to 1050° C. The gaseous ambient temperature, for example, can be an oxygen, nitrogen, argon, or vacuum environment. At this point, the YIG seed layer is crystalized into a predominantly garnet phase suitable as a seed layer for the MO layer 120.

Fourth, form a Ce:YIG layer (magneto-optic layer 120) on the seed layer. The magneto-optic layer 120 can be formed using, for example, the RF sputtering technique or pulsed laser deposition. Use of the RF sputtering technique may provide films having good uniformity and low surface roughness. RF sputtering of Ce:YIG layer may be achieved, for example, by simultaneously sputtering a cerium metal target and a Y3Fe5 target, or by sputtering a Ce—Y—Fe composite target. The thickness of the MO layer 120 can vary from about 100 nm to 1000 nm. The resulting Ce:YIG layer is typically amorphous at this point.

Fifth, anneal the Ce:YIG layer to crystalize the Ce:YIG layer to form a garnet phase. The annealing can be performed using, for example, the RTA technique. The duration, temperature profile, and gaseous ambient can be set to achieve optimal garnet-crystallization of the Ce:YIG layer. For example, the duration can range from 1 minute to 5 minutes, and the annealing temperature can range from 750° C. to 1050° C. The gaseous ambient temperature, for example, can be an oxygen, nitrogen, argon, or vacuum environment. At this point, the Ce:YIG layer is crystallized into a predominantly garnet phase, which provides high level of Faraday rotation (e.g., about −3700°/cm).

While Ce:YIG is provided as an example of MO layer 120, other materials can be used. Examples of alternative materials for MO layer 120 include Bi:YIG (about −1700°/cm), TIG (about 500°/cm), Bi:TIG (about −500°/cm), and Ce:TIG (about −2600°/cm). For doped TIG materials, seed layer 224 may not be necessary. Such omission of seed layer 224 may be beneficial for fabricating devices using lithography because the resist has to be removed before a seed layer is annealed, which is then followed by a second lithography step for the MO layer deposition.

Sixth, form a reflector on the Ce:YIG layer. For example, the reflector can be a DBR. A DBR can be formed by alternatively forming a low index layer and a high index layer. For example, the low index layer can be silicon dioxide (SiO₂) and the high index layer can be amorphous YIG or amorphous TIG. The use of these materials may be beneficial in reducing the number of necessary targets in the sputtering chamber, but other material stacks are possible if there are no constraints on the number of targets. In general, any alternating stacks of high/low index layers can be used from, for example, SiO₂, Si₃N₄, TiO₂, Ta₂O₅ and any other material that is transparent at the wavelength of interest. The layers can be formed using deposition techniques such as RF sputtering, plasma-enhanced vapor deposition (PECVD), and low pressure chemical vapor deposition (LPCVD).

The reflector is not annealed, as the functionality of the reflector is provided by the refractive index contrast of the low and high index layers, and not by the magneto-optic property of a layer of the reflector. The lack of annealing steps for the reflector 130 mitigates stress and cracking of the underlying MO layer 120.

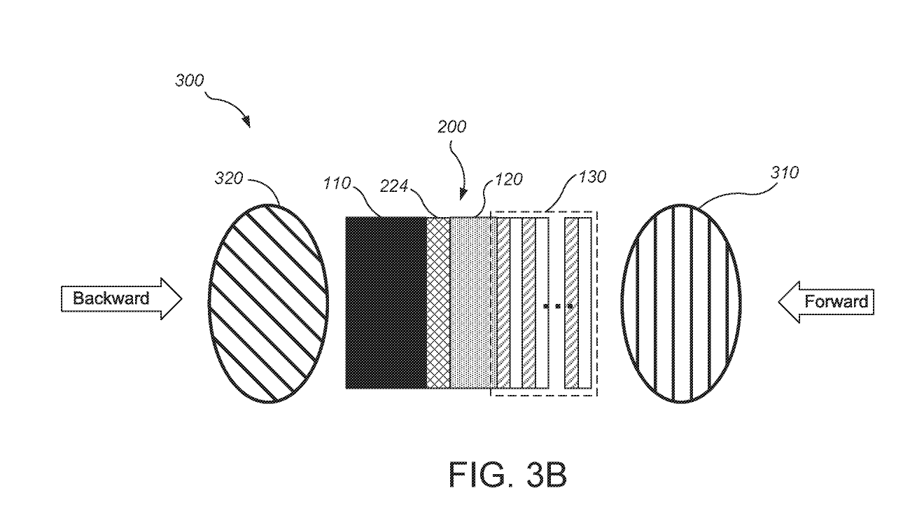

Referring to FIGS. 3A and 3B, schematic views of an example of an optical isolator implemented using the Faraday rotator of FIG. 2 are shown. In the embodiment shown in FIG. 3A, the optical isolator 300 includes the Faraday rotator 200, and an input polarizer 310. The input polarizer 310 is placed at a first side of the Faraday rotator 200, (e.g. the reflector side). The input polarizer 310 has a first polarization axis. For example, the first polarization axis can be vertically oriented.

When a linearly polarized beam aligned with the first polarization axis of the input polarizer 310 is incident on the optical isolator 300, the light passes through the input polarizer 310 without being attenuated. When the linearly polarized light passes through the Faraday rotator 200 in the forward direction under the application of a magnetic field, its polarization rotates by a predetermined amount (e.g. 10°) in, for example, the clockwise direction with respect to the forward propagation direction. Any back-reflected light that propagates through the isolator in a backward direction will be rotated by the same predetermined amount in, for example, the counter-clockwise direction with respect to the propagation direction of the backward propagating light. The counter-clockwise rotation further misaligns the polarization of the reflected light with respect to the first polarization axis of the input polarizer 310 (e.g., 20°), resulting in an increased attenuation of the reflected light by the input polarizer 310. Therefore, back reflected light can be attenuated by the input polarizer without impacting the transmission of the forward propagating light.

In some implementations, multiple Faraday rotators 200 can be provided along the optical path between the input polarizer 310 and the output polarizer 320 (shown in FIG. 3B) to provide additional Faraday rotation. For example, the multiple Faraday rotators 200 can be provided to achieve a cumulative Faraday rotation of 45°. In the embodiment shown in FIG. 3B, an output polarizer 320 is provided at a second side of the Faraday rotator 200, (e.g. the substrate side). The output polarizer 320 has a second polarization axis. The second polarization axis can be arranged at a 45 degree angle relative to the first axis of polarization of the input polarizer 310. In such a configuration, the optical isolator can achieve optimal optical isolation, as 45° of Faraday rotation enables maximum attenuation of the backward propagating light by the polarizers.

Other implementations may include two optical fiber paths that form an interferometer with a Faraday rotator mirror. Such implementations may be used for measuring gravitational waves and in seismic acquisition.

While operations of the Faraday rotator and property of the materials have been discussed at the wavelength of 1550 nm, in general, the Faraday rotator can be designed for and operated at other wavelengths, such as 700-900 nm for plasmonics and/or atomic clocks. Faraday rotation (and sometimes loss) increases in general with decreasing wavelengths.

### EXAMPLES

### FP Faraday Rotator Fabrication

An example of the rotator 200 have been fabricated by the following steps, which resulted in a Faraday rotator capable of providing 10° of rotation at input wavelength of 1550 nm.

First, a silicon substrate was provided.

Second, a seed layer of YIG was deposited. For the seed layer, a Y₃Fe₅ target was sputtered at 240 W, flowing in Ar at 20 sccm and O₂ at 2.0 sccm. The chamber pressure varied between 2.2×10⁻³-2.4×10⁻³ Torr. The thickness of the deposited seed layer was approximately 55 nm.

Third, the YIG seed layer was then annealed using rapid thermal annealing (RTA) for 2 minutes at 900° C. in an O₂ environment.

Fourth, a Ce:YIG layer was grown by sputtering a Ce metal target at 40 W along with the Y₃Fe₅ target at 240 W. O₂ was flown in at 1.8 sccm. The thickness of the deposited Ce:YIG layer was approximately 300 nm.

Fifth, the Ce:YIG film was annealed using RTA for 2 minutes at 900° C. in an O₂ environment.

Sixth, alternating stack of YIG and SiO₂ layers were deposited, for total of 10 layers (5 bilayers). The amorphous YIG film was grown by sputtering a Y₃Fe₅ target at 240 W. The SiO₂ film was grown by sputtering a Si target at 250 W. Both were done at an Ar flow rate of 20 sccm and O2 flow of 2.0 sccm.

This fabrication method produced a film of Ce;YIG that has a predominantly garnet phase. X-ray diffraction was performed using Bruker D8 Discover instrument to analyze the crystal structure of the fabricated YIG seed layer and the Ce:YIG film. The results showed that both the YIG seed layer and the Ce:YIG films are of single phase garnet.

The resulting Faraday rotator 200 fabricated using the described method produced a peak in total reflection of 55%, and a Faraday rotation of 10° at an input wavelength of 1550 nm.

A number of embodiments have been described. Nevertheless, it will be understood that various modifications may be made without departing from the spirit and scope of the invention. Accordingly, other embodiments are within the scope of the claims.

What is claimed is:

1. A Faraday rotator, comprising:
a first reflector comprising a silicon substrate;
a magneto-optic layer on the first reflector, the magneto-optic layer having a figure of merit of at least −1200° per centimeter for a predetermined wavelength of input light; and
a second reflector on the magneto-optic layer, wherein the first reflector, the magneto-optic layer, and the second reflector are arranged to form an optical cavity.

2. The Faraday rotator of claim 1, wherein the magneto-optic layer comprises cerium-doped yttrium iron garnet (Ce:YIG) or cerium-doped terbium iron garnet (Ce:TIG) having a predominantly garnet phase.

3. The Faraday rotator of claim 2, wherein the Ce:YIG or Ce:TIG is polycrystalline.

4. The Faraday rotator of claim 2, wherein a thickness of the magneto-optic layer is in a range of 100 nm to 1000 nm.

5. The Faraday rotator of claim 1, wherein the second reflector comprises a plurality of low refractive index layers and a plurality of high refractive index layers, the low refractive index layers and the high refractive index layers arranged in an alternating manner along a direction perpendicular to the substrate.

6. The Faraday rotator of claim 5, wherein the plurality of high refractive index layers comprises amorphous-YIG, and the plurality of low refractive index layers comprises SiO₂.

7. The Faraday rotator of claim 5, wherein each layer of the plurality of high refractive index layers has a thickness that corresponds to a quarter of a predetermined wavelength of light in the high refractive index layer, and
wherein each layer of the plurality of low refractive index layers has a thickness that corresponds to a quarter of the predetermined wavelength of light in the low refractive index layer.

8. The Faraday rotator of claim 5, wherein respective plurality of first and second reflector layers comprise a range of 2 to 10 layers.

9. The Faraday rotator of claim 1, wherein the first reflector comprises a seed layer on the substrate, the seed layer arranged between the substrate and the magneto-optic layer.

10. The Faraday rotator of claim 9, wherein the seed layer comprises yttrium iron garnet (YIG) having a predominantly garnet phase.

11. The Faraday rotator of claim 10, wherein the YIG is polycrystalline.

12. The Faraday rotator of claim 10, wherein a thickness of the seed layer is between 20 nm and 100 nm.

13. A method of fabricating a Faraday rotator, comprising:
providing a silicon substrate;
forming a yttrium iron garnet (YIG) layer on the silicon substrate;
annealing the YIG layer to crystalize the YIG layer to form a garnet phase;
forming a cerium-doped YIG layer on the YIG layer;
annealing the cerium-doped YIG layer to crystalize the cerium-doped YIG layer and form a garnet phase; and
forming a reflector on the cerium-doped YIG layer.

14. The method of claim 13, wherein the forming of the YIG layer comprises:
sputtering a Y₃Fe₅ target in an O₂ environment.

15. The method of claim 13, wherein the forming of the cerium-doped YIG layer comprises:
simultaneously sputtering a cerium metal target and a Y₃Fe₅target.

16. The method of claim 13, wherein the annealing of the YIG layer comprises rapid thermal processing the YIG layer for 120 seconds at 900° C. in an O₂ environment, and
wherein the annealing of the cerium-doped YIG layer comprises rapid thermal processing the YIG layer for 120 seconds at 900° C. in an O₂ environment.

17. The method of claim 13, wherein the forming of the reflector comprises forming a quarter wavelength reflector stack on the cerium-doped YIG layer.

18. An optical isolator, comprising:
an input polarizer having a first axis of polarization; and
a Faraday rotator comprising:
a first reflector comprising a silicon substrate;
a magneto-optic layer on the first reflector, the magneto-optic layer having a figure of merit of at least −1200° per centimeter for a predetermined wavelength of input light; and
a second reflector on the magneto-optic layer, wherein the first reflector, the magneto-optic layer, and the second reflector are arranged to form an optical cavity.
